(19) United States
(12) Patent Application Publication
(10) Pub. No.: US 2011/0246305 A1
(43) Pub. Date: Oct. 6, 2011

(54) ADVERTISING WEBSITE

(76) Inventor: DANIEL M. BRAZEAU, Gatineau (CA)

(21) Appl. No.: 13/078,814

(22) Filed: Apr. 1, 2011

Related U.S. Application Data
(60) Provisional application No. 61/282,812, filed on Apr. 5, 2010.

(51) Int. Cl. G06Q 30/00

(52) U.S. Cl. 705/14.58

(57) ABSTRACT

The advertising website is a membership-based website that performs a comparative analysis of products and prices offered by retailers in a local community while permitting the user to shop online. The site provides this service at no cost to online shoppers. Moreover, the site provides critical and specific information to the user, such as where, when, how, and at what cost he or she may purchase the product “locally.” The membership base is made up of advertising agencies. The agencies pay a set fee, plus taxes, for twelve-month membership contracts. Under contract, the agencies are permitted to sell unlimited amounts of download space for a fixed and non-negotiable cost to as many retail store customers as desired.

### CROSS-REFERENCE TO RELATED APPLICATION

This application claims the benefit of U.S. Provisional Patent Application Ser. No. 61/282,812, filed Apr. 5, 2010.

### BACKGROUND OF THE INVENTION

1. Field of the Invention

The present invention relates generally to a system and method that provides retail prices comparisons, and more specifically, to an advertising website that provides retail price comparisons of products offered by merchants local to a user of the website.

2. Description of the Related Art

It goes without saying that our society is presently confronted with ecological and environmental problems or issues if you wish, knowing full well that we are the only ones with the possibility of changing the consequences. Even though every one of us are aware of this, only a very few worldwide are making constant efforts and sacrifices to change any of it.

Here are additional facts and figures, 7.9 billion dollars spent on line in 2005, significantly more in 2007 with a tally of 12.8 billion dollars, which represents a 62% increase. If that does not scare you, keep in prospective that the increase spent abroad is also of 60% with a higher cost of 56 percent. Interestingly enough, the age group adults 25-34 made more than half of the on line orders for a number of 51%. Forty-three percent of Canadians went on line in 2007 to compare products or do some window-shopping, as we say. To my knowledge, the most important figure of all is that 64% of them declared having purchased an item subsequently within 14 days, but preferred to purchase in store rather than use a credit card on line.

One of the primary reasons that will bring the company immediate success and longevity is a no charge policy to the web user, meaning no club fee or membership fee whatsoever, once he or she has discovered our website, and has made a few product and price comparisons in his or her respective local market, we feel without a doubt that this free of charge, efficient and entertaining service will have them come back for more.

Here is our solution for concern number two; only advertising agencies will be permitted to engage in a very simple membership contract based on a 12 consecutive month term in which the agency is to be billed $1,500.00 monthly plus G.S.T. and applicable provincial sales tax, and a 15% maintenance and update fee. Once the agency has become a www.croclocal.ca member, they are therefore permitted to sell unlimited amounts of download space to as many customers as desired coast-to-coast.

The fixed and non-negotiable costs to the agency's local retail customer are based on city and state population as reflected in rate cards developed for the specific advertising locales, in the case where one as many outlets, the cost may be divided equally amongst the stores in any given market.

Thus, an advertising website solving the aforementioned problems is desired.

### SUMMARY OF THE INVENTION

The advertising website is a membership-based website that performs a comparative analysis of products and prices offered by retailers in a local community while permitting the user to shop online. The site provides this service at no cost to online shoppers. Moreover, the site provides critical and specific information to the user, such as where, when, how, and at what cost he or she may purchase the product “locally.” The membership base is comprised of advertising agencies. The agencies pay a set fee, plus taxes, for twelve-month membership contracts, and a 15% maintenance and update fee. Under contract, the agencies are permitted to sell unlimited amounts of download space for a fixed and non-negotiable cost to as many retail store customers as desired.

These and other features of the present invention will become readily apparent upon further review of the following specification and drawings.

### BRIEF DESCRIPTION OF THE DRAWINGS

FIG. 1 is a diagrammatic view of a system providing the advertising website according to the present invention.

FIG. 2 is a screenshot showing the user and ad agency interface, according to the present invention.

FIG. 3 is a flowchart showing the advertising website process according to the present invention.

Similar reference characters denote corresponding features consistently throughout the attached drawings.

### DETAILED DESCRIPTION OF THE PREFERRED EMBODIMENTS

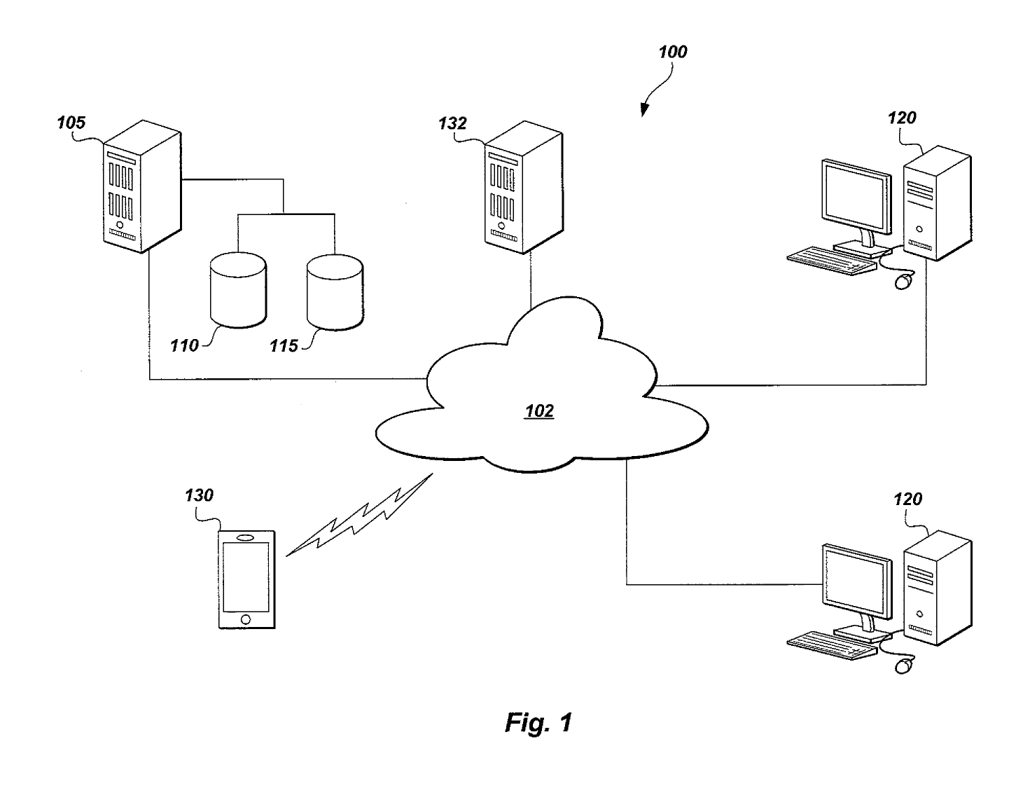

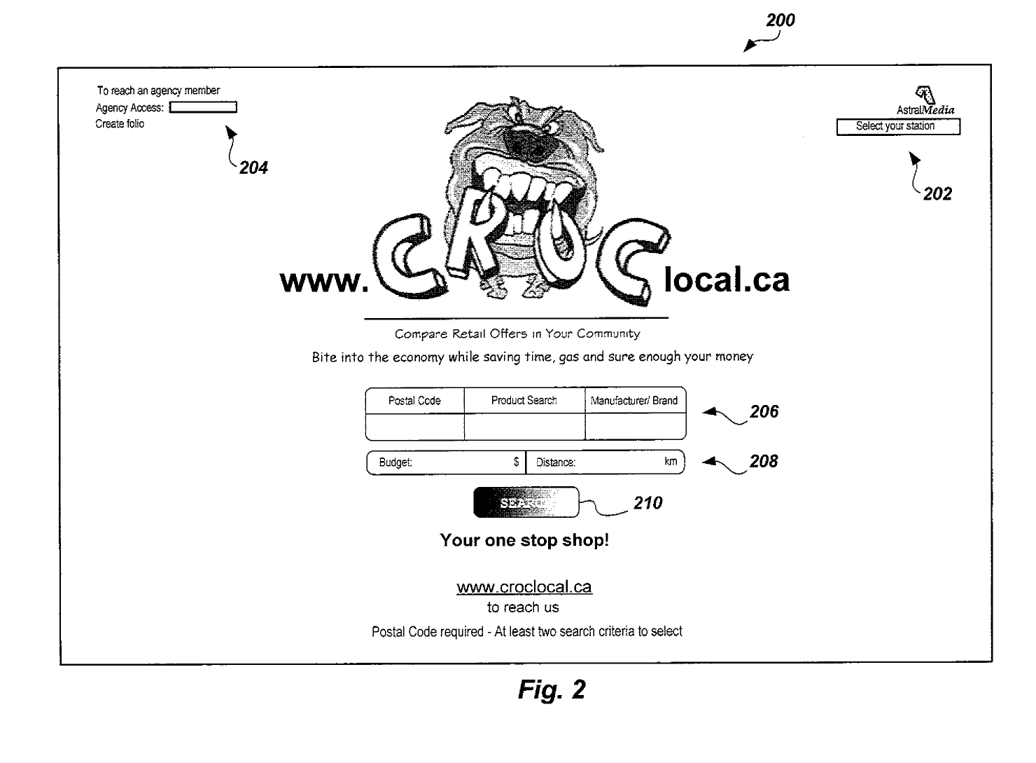

As shown in FIGS. 1-3, the advertising website 200 provides a retail product and price comparisons portal capable of displaying product and price information offered by retailers who are geographically local to the website user (consumer). The infrastructure 100 utilized by website 200 includes Internet 102, and a plurality of servers and web-enabled user devices. The website 200 may be hosted on a server 105 accessible via the Internet 102. User devices are web-enabled computers 120 or may also be a web enabled wireless mobile device, e.g., cellular telephone 130. Databases 110, 115 and servers 105 may be distributed in regional centers, localized, and/or be ubiquitously present within the Internet cloud 102. It should be understood that the advertising website 200 may be embodied in general purpose computer(s) having the appropriate peripherals attached thereto and software stored on a computer readable media that can be loaded into main memory and executed by a processing unit to carry out the functionality of the inventive website and steps of the inventive website method described herein.

The website 200 may provide a downloadable application available to mobile device 130 to enable the mobile device 130 to receive advertising and price comparison information automatically based on GPS coordinates or other geospatial indicia of device 130's whereabouts. A web page/agency membership data store 110 and a product-price comparison data store 115 are available to support databases having agency membership information, product-price, and retailer geographical information. Users' web-enabled computers 120 access a search engine on website 200 optimized for providing local retail bargains.

The homepage of website 200 provides user input fields 206 for a postal code, product search, and manufacturer/brand name. A user's budget and geographic distance requirements are entered in the constraints fields 208. Search button 210 is provided to initiate search once the user has entered the required search criteria. Additionally, the website 200 accepts a plurality of streaming media sources, e.g., streaming media server 132, from the Internet 102 and the user will be able to listen to his/her favorite radio station on a variety of stations operated by at least one streaming media service provider. A selection button 202 is provided on the homepage of the website 200. The homepage of website 200 has an agency member login field 204 where an agency can login with user name and password, or establish a new account.

All the product-price information is based on specific local markets (cities). Moreover, there are no club fees or membership fees to the user. The site does not take a percentage commission of the price of the products sold thereon. Additionally, economic viability of the site does not depend on user click through habits.

The revenue from site operations comes from annual contract memberships sold to local, regional and national advertising agencies representing the retailers. Thus, the inventive website 200 becomes a warehouse of (virtual) space for local advertising. The agencies are used as brokers to sell virtual storage space available via the Internet 102.

For example, when an agency commits to a 12-month website access deal at $1,500 a month, the agency is allocated an unlimited (virtual) space. In turn, the agency sells, at specific rates reflecting market size and population, pieces of the virtual space to as many retailers as the agency can find. The agency logs in with its account number and password, and then simply downloads the retailers' product information into the database residing on mass storage unit 115. Advantageously, overhead cost is minimal, requiring very few representatives/agents. However a greater number of IT professionals are expected to keep the website 200 operational.

The local aspect of price-product comparison is maintained automatically via traditional database methodologies. Additionally, novel fuzzy logic heuristics and algorithms are used to gather and extract local retail data. This process is secure (e.g., agency transactions may occur on HTTPS ports), thereby ensuring that the created database is secure.

The website restricts database manipulation exclusively to member advertising agencies, i.e., retailers may only purchase the advertising space through a member advertising agency. Part of the membership agency process involves the agency creating its own Agency folio on line.

Moreover, an on-line terms of membership agreement is provided on the website 200 and, online, the agency must agree to the terms presented by the website. The website-provided membership terms, which must be accepted by the applying advertising agency, include the requirement in which the agency must pay, e.g., a base monthly fee of $1,500.00.

The advertising agency is allowed to retain, e.g., 85% of the revenue generated by the advertising agency. The remaining 15% is paid to principals of the website, e.g., website owner. Optionally, this remaining 15% may be referred to as a maintenance and site update fee. Additional revenue is generated by the website through the use of non-retail level corporate banner sponsorship Ads disposed on the website 200. A particular embodiment of the on-line membership agreement includes a first membership option (“AAA” membership) in which the agency chooses to pay a $1500.00 monthly membership fee, the agency being able to retain, for example, 75% of all revenues it is to generate monthly. A second membership option (“AA” membership) is provided in which the agency chooses to pay a $750.00 monthly membership fee and retains 60% of all revenues it is to generate monthly. A third membership option is (“A” membership) is provided in which the agency pays no monthly membership fees, the agency retaining 50% of all revenues it is to generate monthly.

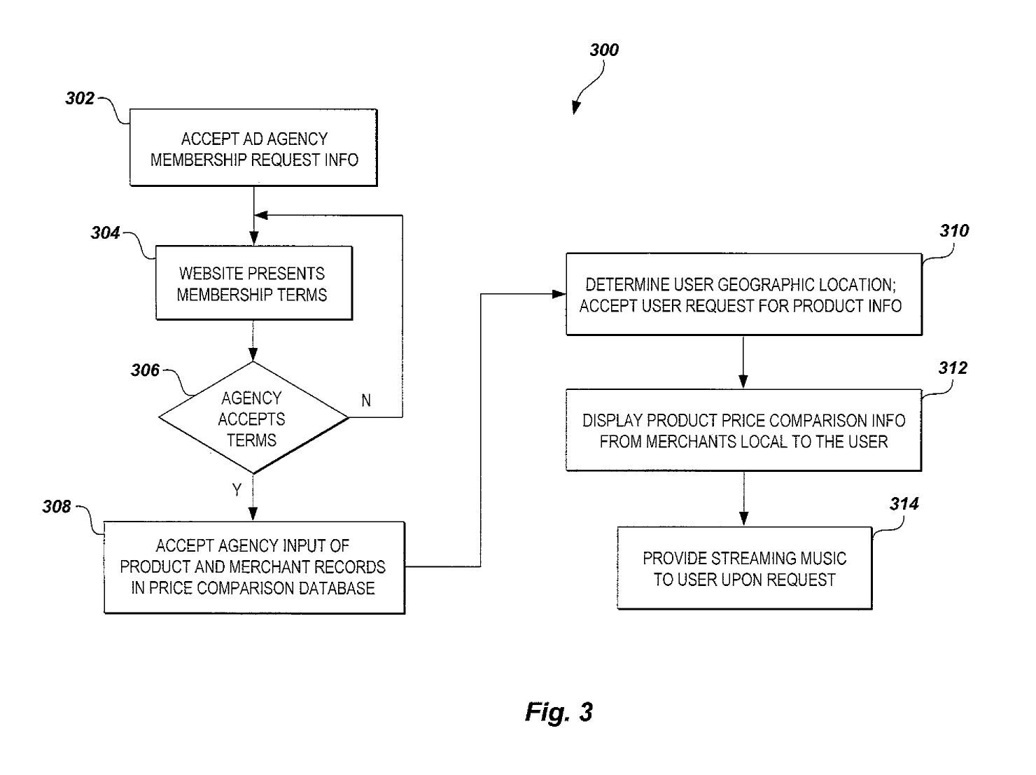

As most clearly shown in FIG. 3, the advertising website business logic 300 is a set of steps which can be encoded in the server 105. The data store 115 is empty until at least one agency signs up for membership. As shown in FIG. 3, at step 302 the system accepts ad agency membership request information. At step 304 the website 200 presents the membership contract. If the agency accepts the terms at step 306, then the website accepts agency input of product and merchant records into a price comparison database at step 308. With respect to the consumer users, after at least one product and merchant record has been entered into the database, the system is ready to determine user geographic location and accept the users' request for product information at step 310. At step 312 the product price comparison information from local merchants is displayed by the website 200. Streaming radio output is provided at step 314 if requested by the user.

It is to be understood that the present invention is not limited to the embodiment described above, but encompasses any and all embodiments within the scope of the following claims.

I claim:

1. An advertising website, comprising:
a website connected to the Internet;
mass storage;
a product advertising database disposed in the mass storage, the product advertising database being in operable communication with the website;
means for providing a local product price comparison user interface on the website, the local product price comparison user interface presenting product price comparisons of a product that a user is interested in, the product price comparisons being restricted to products offered by retail merchants geographically local to the user;
means for exclusively allowing advertising agencies who become members of the website to populate and maintain the product advertising database; and
means for presenting terms of membership to the advertising agencies, the terms of membership including a fixed base monthly fee to be paid by the advertising agencies, the terms of membership further providing that a fixed percentage of revenue generated by the advertising agencies is to be retained by the advertising agencies, the balance of the revenue generated by the advertising agencies less the fixed percentage being retained by principals of the website.

2. A computer-implemented advertising website method, comprising the steps of:
making a website available to a consumer user on the Internet;
disposing a product advertising database in a mass storage area, the product advertising database being in operable communication with the advertising website;
providing a local product price comparison user interface on the website, the local product price comparison user interface presenting product price comparisons of a product that said consumer user is interested in, the product price comparisons being restricted to products offered by retail merchants geographically local to the consumer user;
allowing only advertising agencies who become members of the website to populate and maintain the product advertising database; and
presenting terms of membership to the advertising agencies, the terms of membership including a fixed base monthly fee to be paid by the advertising agencies, the terms of membership further providing that a fixed percentage of revenue generated by the advertising agencies is to be retained by the advertising agencies, the balance of the revenue generated by the advertising agencies less the fixed percentage being retained by principals of the website.

3. The computer-implemented advertising website method according to claim 2, further comprising the step of requiring a product search criterion entry from the consumer user.

4. The computer-implemented advertising website method according to claim 3, further comprising the step of accepting a manufacturer and brand name entry from the consumer user.

5. The computer-implemented advertising website method according to claim 3, further comprising the step of accepting a postal code entry from the consumer user.

6. The computer-implemented advertising website method according to claim 3, further comprising the step of accepting a budget entry from the consumer user.

7. The computer-implemented advertising website method according to claim 3, further comprising the step of accepting a distance entry from the consumer user.

8. The computer-implemented advertising website method according to claim 3, wherein said local product price comparisons presentation step further comprises using geographic information specifically entered by the user on said website in determining locality of s products presented to the user.

9. The computer-implemented advertising website method according to claim 3, wherein said local product price comparisons presentation step further comprises using information based on GPS coordinates or other geospatial indicia of a web-enabled device of the user in operable communication with said website in determining locality of products presented to the user.

10. The computer-implemented advertising website method according to claim 3, further comprising the steps of accepting a plurality of streaming media sources from the Internet and allowing the consumer user to select/hear/view contents streamed by the streaming media sources.

11. The computer-implemented advertising website method according to claim 3, further comprising the step of automatically gathering and extracting local retail data to update price and product information in said product advertising database.

12. The computer-implemented advertising website method according to claim 3, further comprising the step of generating additional revenue via the use of non-retail level corporate banner sponsorship Ads disposed on the website.

13. The computer-implemented advertising website method according to claim 3, wherein said fixed base monthly fee is zero.

14. A computer software product, comprising a medium readable by a processor, the medium having stored thereon a set of instructions for implementing an advertising website, the set of instructions including:
(a) a first sequence of instructions which, when executed by the processor, causes said processor to make a website available to a consumer user on the Internet;
(b) a second sequence of instructions which, when executed by the processor, causes said processor to dispose a product advertising database in a mass storage area, the product advertising database being in operable communication with the advertising website;
(c) a third sequence of instructions which, when executed by the processor, causes said processor to provide a local product price comparison user interface on the website, the local product price comparison user interface presenting product price comparisons of a product that the is consumer user is interested in, the product price comparisons being restricted to products offered by retail merchants geographically local to the consumer user;
(d) a fourth sequence of instructions which, when executed by the processor, causes said processor to allow only advertising agencies who become members of the website to populate and maintain the product advertising database; and
(e) a fifth sequence of instructions which, when executed by the processor, causes said processor to present terms of membership to the advertising agencies, the terms of membership including a fixed base monthly fee to be paid by the advertising agencies, the terms of membership further providing that a fixed percentage of revenue generated by the advertising agencies is to be retained by the advertising agencies, the balance of the revenue generated by the advertising agencies less the fixed percentage being retained by principals of the website.

15. The computer software product according to claim 14, further comprising a sixth sequence of instructions which, when executed by the processor, causes said processor to require a product search criterion entry from said consumer user.

16. The computer software product according to claim 15, further comprising a seventh sequence of instructions which, when executed by the processor, causes said processor to accept a manufacturer and brand name entry from the consumer user.

17. The computer software product according to claim 15, further comprising an eighth sequence of instructions which, when executed by the processor, causes said processor to accept a postal code entry from the consumer user.

18. The computer software product according to claim 15, further comprising a ninth sequence of instructions which, when executed by the processor, causes said processor to accept a budget entry from the consumer user.

19. The computer software product according to claim 15, further comprising a tenth sequence of instructions which, when executed by the processor, causes said processor to use geographic information specifically entered by the user on said website in determining locality of products presented to the user.

20. The computer software product according to claim 15, further comprising an eleventh sequence of instructions which, when executed by the processor, causes said processor to use information based on GPS coordinates or other geospatial indicia of a web-enabled device of the user in operable communication with said website in determining locality of products presented to the user.

21. The computer software product according to claim 15, further comprising:
a twelfth sequence of instructions which, when executed by the processor, causes said processor to accept a plurality of streaming media sources from the Internet and to allow the consumer user to select/hear/view contents streamed by the streaming media sources;
a thirteenth sequence of instructions which, when executed by the processor, causes said processor to automatically gather and extract local retail data to update price and product information in said product advertising database; and
a fourteenth sequence of instructions which, when executed by the processor, causes said processor to generate additional revenue via the use of non-retail level corporate banner sponsorship Ads disposed on the website.

22. The computer software product according to claim 15, wherein said fixed base monthly fee is zero.
